(19) United States
(12) Patent Application Publication
(10) Pub. No.: US 2010/0302009 A1
(43) Pub. Date: Dec. 2, 2010

(54) DATA EXCHANGE WITH AN M2M DEVICE USING SHORT RANGE RADIO COMMUNICATION

(75) Inventors: Sebastiaan Hoeksel, Maastricht (NL); Robert van Muijen, As (BE); Patrick H. Waters, Redlynch Salisbury (GB)

Correspondence Address: International IP Law Group, P.O. BOX 691927, HOUSTON, TX, 77269-1927, US

(73) Assignee: Vodafone Holding GmbH, Dusseldorf (DE)

(21) Appl. No.: 12/790,422

(22) Filed: May 28, 2010

(30) Foreign Application Priority Data
Jun. 2, 2009 (EP) 09007300.8

(51) Int. Cl. H04Q 5/22; H04B 5/00; H04B 7/00

(52) U.S. Cl. 340/10.1; 455/41.1; 455/41.2

(57) ABSTRACT

Exemplary embodiments of the invention relate to a device attachable to an object and comprising a control module for receiving measuring data from at least one sensor and/or for controlling at least one actuator. The device further comprises a communication module for communicating with an external reader unit via a radio connection using a radio field. During the communication with the reader unit the communication module can be supplied with power using the radio field. The communication module may be configured to store data received from t reader unit in a memory of the device and/or to read data to be transmitted to the reader unit from the memory, while the communication means is supplied with power using the radio field. Exemplary embodiments also relate to methods for communicating with the device.

### CROSS REFERENCE TO RELATED APPLICATION

This application claims priority to European (EP) Patent Application No. 09 007 300.8, filed on Jun. 2, 2009, the contents of which are incorporated by reference as if set forth in their entirety herein.

### BACKGROUND

The term machine-to-machine technology or the alternative terms man-to-machine, machine-to-man, machine-to-mobile and mobile-to-machine technology, which are all abbreviated as M2M technology, generally referred to data communications between machines. In particular, the M2M technology allows for accessing objects or functionalities of objects from a remote location. Typically, the M2M technology is used for collecting information, sending indications of unusual situations, and setting parameters or otherwise controlling devices from remote locations. For this purpose M2M devices comprising suitable sensors and/or actuators may be attached to the object which is monitored or controlled. One example is an M2M device or tag that is attached to a container and signals the location of the container or other measured parameters to a remote location. One possibility to connect an M2M device and the remote location is to set up a connection via a mobile communication network.

An M2M device usually comprises a control module including application logic for controlling the sensors and/or actuators. Furthermore, the control module may be configured to control the data exchange between the M2M device and the remote location. Moreover, an M2M device usually stores data identifying and/or describing the object to which it is attached. In order to use an M2M device in different circumstances and in connection with different objects, it is advantageous that the application logic and further data stored in the M2M device can be configured by the user of the device. This allows a user to adapt a generic M2M device to his needs. One possibility for allowing the user to configure the M2M device would be to provide the M2M device with a user interface comprising a display and an input unit that allows the user to configure the device. However, a user interface would make the M2M more complex and costly. In addition, the M2M device would have to be supplied with power, when it is configured by means of a user interface. However, the M2M device may only be powered at its site of operation. This may be the case when the M2M device is energized by an external power supply at the site of operation or when an internal battery of the device is charged using energy conversion from light or movement at the site of operation. This makes it at least difficult to configure the M2M device before it is installed at its site of operation. Therefore, there is a need for an M2M device, which can be configured without using a user interface of the device and independent of a power supply of the device.

Furthermore, the M2M device may store data collected during the operation of the device. These data may be measuring data of one or more sensors of the device. It would again be possible to provide the M2M device with a user interface allowing reading such data from the device.

### SUMMARY

An exemplary embodiment of the present invention relates to machine-to-machine technology. More specifically, an exemplary embodiment relates to a device attachable to an object and comprising a control module for receiving measuring data from at least one sensor and/or for controlling at least one actuator. Moreover, an exemplary embodiment provides the ability to be able to read data without using a user interface of an M2M device and independent of a power supply of the device. Furthermore, exemplary embodiments relate to methods for communicating with the device.

In one exemplary embodiment, communication with an M2M device is independent of a power supply of the device.

In an exemplary embodiment, a device attachable to an object is suggested. The device comprises a control module for receiving measuring data from at least one sensor and/or for controlling at least one actuator. The device further comprises a communication module for communicating with an external reader unit via a radio connection using a radio field. During the communication with the reader unit the communication module can be supplied with power using the radio field, and the communication module is configured to store data received from the reader unit in a memory of the device and/or to read data to be transmitted to the reader unit from the memory, while the communication module is supplied with power using the radio field.

An exemplary method for communicating with a device is suggested. The exemplary method comprises the steps of:
establishing a radio connection between a communication module of the device and a reader unit using a radio field generated by the reader unit,
during the communication supplying the communication module with power using the radio field,
the communication module storing data received from the reader unit in a memory of the device, while the communication module is supplied with power by the radio field, and
forwarding the stored data from the memory to the control module of the device, when the control module is supplied with power by the power supply of the device.

One exemplary embodiment relates to a further method for communicating with the device. The method comprises the steps of:
the control module collecting data during the operation of the device and storing the data in the memory of the device, while the control module is supplied with power by a power supply of the device,
establishing a radio connection between a communication module of the device and a reader unit using a radio field generated by the reader unit,
during the communication supplying the communication means with power using the radio field,
the communication module reading a data from the memory and transmitting the data to the reader unit, while the communication module is supplied with power by the radio field.

An exemplary embodiment relates to a device, particularly an M2M device, with a communication module, that can be supplied with power by an external radio field generated by a reader unit when the reader unit communicates with the device. Furthermore, a memory is provided in the device which can be accessed by the communication module, while the communication module is supplied with power by the radio field generated by the reader unit, and which can be accessed by the control module, when the control module is energized by the power supply means of the device. Via the memory, data can be exchanged between the reader unit and the control module of the device. Thus, the communication between the reader unit and the control module of the device is independent of the power supply of the control module and a user interface of the device is not required for communicating with the device.

In one exemplary embodiment of the device and the methods, the device further comprises a radio module for communicating with a remote location via a communication network, particularly via a mobile communication network. Using the radio module measuring data of the sensor of the device may be sent to the remote location, thereby allowing monitoring the object to which the device is attached from the remote location. Furthermore, the device may be controlled from the remote location using commands transmitted to the device via the communication network.

In a further exemplary embodiment of the device and the methods, the radio connection comprises a wireless short range connection. In particular, the radio connection may be an NFC (Near Field Communication) connection, and the control module may be an NFC-enabled module operating in a passive communication mode, when communicating with the reader unit. With the NFC technology an existing technology for short range communication can be used to establish a communication connection between the reader unit and the communication module of the device. Further on, the NFC technology already provides a passive communication mode, in which one of the communication partners can be powered by the radio field generated by the other communication partner.

One exemplary embodiment of the device and the methods provides that the device further comprises a power supply and that the stored data received from the reader unit can be forwarded to the control module, when the control module is supplied with power by the power supply. The power supply may be a power connection to an external power supply circuit to which the device may be connected at its site of operation. Likewise, the power supply may be an autarkic internal power supply of the device.

At the time of the communication between the device and the reader unit, the control module does not have to be supplied with power by the power supply means of the device. Preferably, the control module is supplied with power by the power supply upon an activation of the device. The device may be activated, when it is installed at its site of operation. However, data may be transmitted to the device before it is activated and installed at its site of operation.

In one exemplary embodiment of the device and the methods, the data transmitted to the device are configuration data including program routines for controlling the operation of the device. In particular, the configuration data may include program routines for controlling the sensor and/or the actuator of the device. Likewise the program routines included in the configuration data may affect the interaction between the M2M device and the remote location. An exemplary embodiment allows transmitting such configuration data to the device before the device is activated. This is advantageous, when there is a greater time difference between the data transfer and the activation and/or when the configuration data is not transferred to the device at its site of operation.

In a further exemplary embodiment of the device and the methods, the control module is configured to control storage of the data to be transmitted to the reader unit in the memory, while it is supplied with power by the power supply of the device, the data being collected in the operation of the device. The data, which the control module stores in the memory, may be measuring data of the sensor of the device, for example.

A further exemplary embodiment of the device and the methods comprises that the control module is configured to transmit data collected in the operation of the device to the remote location using the radio module.

However, in certain circumstances, it can be advantageous to store data collected in the operation of the device locally in the device instead of or in addition to transmitting the data to the remote location via the communication network. Therefore, in one exemplary embodiment of the device and the methods, the control module is configured to store data collected in the operation of the device, when a predefined condition is fulfilled.

In a related exemplary embodiment of the device and the methods, the condition is fulfilled when a connection to the remote location via the communication network is not available and/or when energy reserves of the power supply are below a predetermined threshold. In the latter case, the energy provided by the power supply means may not be sufficient to energize the radio module and to transmit the data to the remote location. In particular, the radio module may be deactivated when the energy reserves of the power supply means are below the threshold. This also saves energy and prolongs the time of operation of the device.

Furthermore, an exemplary embodiment of the invention relates to a system comprising a device of the type described before and a reader unit. The reader unit is configured to generate a radio field for establishing a radio connection to the device and to receive data from the device or to transmit data to the device via the radio connection.

### BRIEF DESCRIPTION OF THE DRAWINGS

Reference will be made by way of example to the accompanying drawings in which:

FIG. 1 is a block diagram showing an M2M device and a reader device, which can communicate with the M2M device using short range radio communication according to an exemplary embodiment of the present invention.

### DETAILED DESCRIPTION OF SPECIFIC EMBODIMENTS

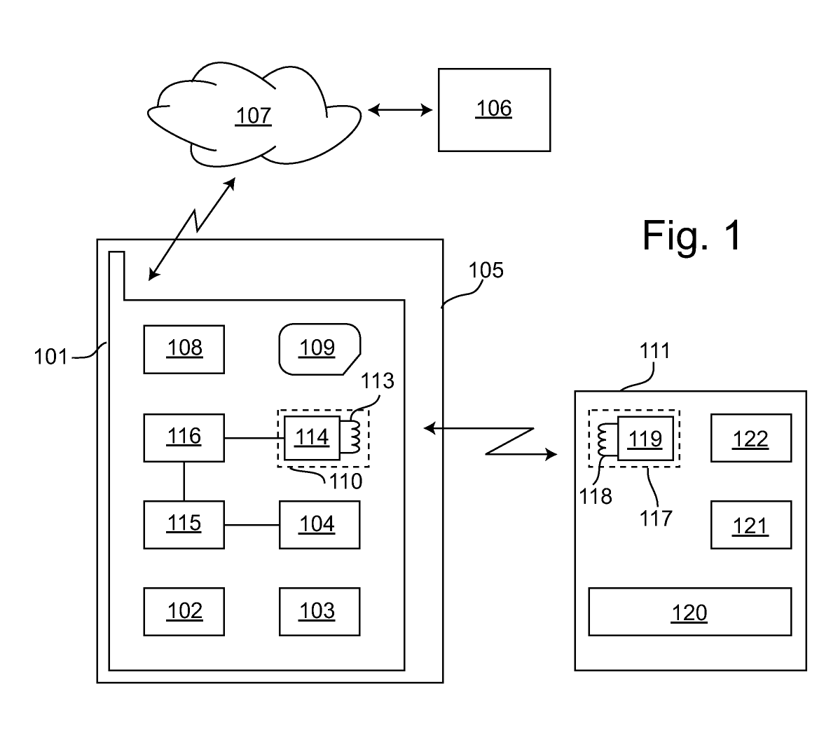

FIG. 1 schematically shows a schematic block diagram of an M2M device 101 removably or permanently attached to an object 105, which can be monitored and/or controlled from a remote location 106 using the M2M device 101.

The M2M device 101 comprises a control module 104, which is coupled to least one sensor 102 and/or at least one actuator 103. The sensor 102 may be integrated into the housing of the M2M device 101 or the sensor 102 is arranged in a separate housing and electrically connected to the control module 104. In the latter case, the M2M device 101 can be used to access sensors 102, which form a component of the object 105 and sensors 102 which are attached to the object 105 in addition to the M2M device 101. As the sensor 102, the actuator 103 can be integrated into the housing of the M2M device 101, or it can be an external actuator 103, which is an integral part of the object 105 or of a further device attached to the object 105. Preferably, the control module 104 can interact with different external sensors 102 and or actuators 104 using different configurations. This is especially advantageous, when the M2M device is used in connection with external sensors 102 and/or actuators 103 and allows an adaption of the M2M device to such sensors 102 and/or actuators 103.

A sensor 102 coupled to the control module 104 is configured to measure certain parameter in connection with the object 105 to which the M2M device 101 is attached. In particular, the sensor 102 may be configured to measure a parameter that is related to the operating conditions within or around the object 105, such as temperature, pressure, humidity or the like. Likewise, the sensor 102 may comprise a unit for determining the position of the object 105, such as, for example, a GPS receiver (GPS: Global Positioning System). In this configuration, the M2M device 101 can be used to track and trace the object 105, particularly on a transportation route. In addition or as an alternative, the sensor 102 may be adapted to detect the operating state of certain components of the object 105, such as, for example, the operating state of a lock mechanism, the operating state of a motor or the like.

An actuator 103 of the M2M device may be adapted to act on the object 105 to which the M2M device 101 is attached or on a component of the object 105. For example, the actuator 103 may comprise a motor or an alternative drive for this purpose. The actuator 103 is controlled by the control module 104 according to a control program, which is stored in the control module 104. The control of the actuator 103 may be based on a fixed procedure. Likewise, the control may be responsive to data measured by one or more sensors 102 of the M2M device 101 in the sense of a closed-loop control.

A connection between the M2M device 101 and the remote location 106 is established via a communication network 107 to which the M2M device 101 can be connected wirelessly. Preferably, the communication network 107 is a mobile communication network, which may be configured according to the GSM or UMTS standard, for example (GSM: Global System for Mobile Communications; UMTS: Universal Mobile Telecommunications System). The remote location 106 may access the mobile communication network 107 directly or via another network, such as, for example, the Internet, which has a gateway to the mobile communication network 107. The communication between the device 101 and the remote location 106 via the mobile communication network 107 may be based on any bearer service provided in the network. Particularly, a bearer service for non-speech data may be used, such as SMS (Short Message Service), USSD (Unstructured Supplementary Services Data), CSD (Circuit Switched Data), HSCSD (High Speed Circuit Switched Data) or GPRS (General Packet Radio System). However, it may likewise be provided to exchange information in the form of speech data using a corresponding bearer service of the mobile communication network 107.

For accessing to the mobile communication network 107, the M2M device 101 comprises a radio module 108 which provides a radio interface for connecting to the mobile communication network 107 and which is configured according to the mobile communication standard on which the mobile communication network 107 is based. The radio module 108 is connected to an identification module 109 for identifying and/or authenticating the M2M device 101 to the mobile communication network 107. The identification module 109 is issued by a mobile network operator and linked to a subscription of the user or owner of the M2M device 101 with the mobile network operator. As it is usually the case in mobile communications, the identification module 109 may be provided on a smartcard, which is inserted into a card reader of the M2M device 101. In particular, if the mobile communication network 107 is a GSM network, the identification module 109 is configured as a SIM (Subscriber Identification Module) card according to the GSM standard comprising a SIM application, which provides the identification and authentication service. If the mobile communication network 107 is a UMTS network, the smartcard 208 is configured as a UICC (Universal Integrated Circuit Card) comprising a USIM (Universal Subscriber Identification Module) application providing the identification and authentication service.

The radio module 108 is coupled to the control module 104, which is likewise connected to the sensor 102 and/or actuator 103 of the M2M device 101. The control module 104 may be configured as a microcontroller comprising a processor for running programs and a memory for storing program code and further data. In order to interact with the sensor 102 and/or actuator 103 the control module 104 may be equipped with an analogue-to-digital converter (ADC) and/or a digital-to-analogue converter (DAC) thereby allowing a data exchange with an analogue sensor 102 or actuator 103. The ADC converts analogue signals received from the sensor 102 or actuator 103 into digital signals before forwarding them to the processor of the control module 104. Similarly, the DAC converts digital signals received from processor into analogue signals that are forwarded to the sensor 102 or actuator 103. In addition or as an alternative, the control module 104 may provide a GPIO interface, for interacting with the sensor 102 and actuator 103 (GPIO: General Purpose Input/Output). Of course, the control module 104 can make use of additional or other interfaces to the sensor 102 and/or actuator 103.

The control module 104 provides application logic to control the sensor 102 and/or actuator 103 and the communication with the remote location 106. Among other functions, the control module 104 is able to request and receive measuring data from the sensors 102. The measuring data may be forwarded to the remote location 106 via the mobile communication network 107 using the radio module 108 and/or the measuring data may be stored locally in the control module 104. Likewise, the control module 104 may be able to evaluate measuring data received from the sensors 102 and send the result of the evaluation to the remote location 106 and/or store the result locally. For instance, this allows for generating summary data from the sensor signals.

Moreover, the control module 104 is able to send control commands to the sensor 102 and/or actuator 103 to control their operations. In particular, the control module 104 may be configured to activate and deactivate the sensor 102 and/or actuator 103 or certain functionalities thereof, to request measuring data from the sensor 102, and to influence operating parameters of the sensor 102 and actuator 103. The control module 104 may operate according to predefined program routines, which are stored in the control module 104. In addition or as an alternative the control module 104 functions of the control module 104 are invoked upon request from the remote location 106. Such requests are sent to the M2M device 101 via the mobile communication network 107 and received using the radio module 108.

Furthermore, the control module 104 preferably comprises management data relating to the object 105 to which the M2M device 101 is attached. These data may include a unique identification which may be linked permanently or temporarily to the object 105. In addition, data describing the object 105 may be stored in the control module 104. For example, in case the object 105 is a shipping container, these data may describe one or more of the following details: the contents of the container and details relating thereto, the container's weight, the container's dimensions, the container's place of origin, its destination, possible interstations of the container, the means of transportation provided for shipping the container, the owner of the container, the sender of the container's contents and the addressee of the contents.

As an alternative to the storage of the management data in the M2M device 101 it may be provided that a database entry comprising the management data is linked to the M2M device 101. The database entry is linked to the M2M device 101 by an identification code assigned to the M2M device 101 and to the database entry. In this embodiment, the control module 104 stores the identification code, which can be used to read the related management data from the database. Preferably, the identification can also be sent from the control module 104 to the remote location 106 to allow the remote location to identify the object 105 to which the M2M device 101 is attached, when the M2M device 101 communicates with the remote location 106. The database storing the management data may be operated at the remote location 106.

As described before, the M2M device 101 can be used in different circumstances and can be attached to different objects 105. In order to facilitate the manufacture and use of the M2M device 101, it does not comprise a fixed configuration, but the configuration can be defined and preferably also modified by a user of the M2M device 101. The option to modify the configuration makes it possible that after a first use an M2M device 101 can be reused with another object 105. The configuration of the M2M device 101 preferably comprises the management data described before and the application logic stored in the control module 104. Thus, one M2M device 101 can be used ubiquitously in a plurality of different applications.

The components of the M2M device 101 are supplied with power by a power supply 112. The power supply 112 may be a power connector connecting the M2M device 101 to an external power supply circuit. Using the power supply 112, the M2M device 101 may be connected to a power supply circuit available at the site of operation of the M2M device 101. This may be a power supply circuit of the transportation vehicle transporting the object 105 or it may be a power supply circuit of the object 105 itself, for example. In further embodiments, the power supply 112 is an autarkic power supply of the M2M device 101 and generates power from chemical or mechanical processes. Examples of such power supply 112 are batteries, solar cells or devices that generate power from movement of the M2M device 101. Furthermore, the power supply 112 may comprise a battery that may be charged during the operation of the M2M device via energy conversion.

Configuration data may be transmitted to the M2M device 101 using a communication interface implementing a wireless short range communication technology. The communication interface includes a communication module 110, which is wirelessly accessible using a reader unit 111. Preferably, the reader unit 111 is a portable handheld device, which can be used by an operator to access the M2M device 101. In this embodiment, a data connection between the reader unit 111 and the communication module 110 can be established when the reader unit 111 is brought in proximity of the M2M device 101. However, the reader unit 111 may also be configured as a stationary device and the M2M may be accessed by bringing the M2M device 101 into proximity of the stationary reader unit.

The communication module 110 comprises an antenna 113 and an antenna controller 114. The antenna 113 is used for sending and transmitting data wirelessly and the antenna controller 114 controls the antenna 113 on a physical level. On the application level, a communication application 116 coupled to the communication module 110, particularly to the antenna controller 114, controls the operation of the antenna 113 and the communication module 110. The antenna controller 114 and the communication application 116 may be integrated into a single chip coupled to the antenna 113. However, in further embodiments, the communication application 116 may not be implemented in one chip together with communication module 110. Rather, the communication application 116 may be integrated into the identification module 109, for example. In this case, the identification module 109 is connected to the control module 104 via an interface allowing a data exchange between the communication application 116 and the communication module 110.

The communication module 110 can be operated in a passive mode, in which it does not need to be energized by the power supply 112 of the M2M device 101. Rather, when exchanging data with the reader unit 111, the communication module 110 is supplied with power inductively using the radio frequency (RF) field generated by the reader unit 111. This RF field induces a current in the antenna 113 of the communication module 110 and thereby energizes the communication module 110. If the communication application 116 is implemented in the control module chip, it can be used when the control module 104 is active. If the communication application 116 is provided by the identification module 109, the identification module 109 may also be supplied with power via a suitable interface between the antenna controller 114 and the identification module 109 in order to be able to run the communication application 116 in the passive communication mode. When the communication module 110 is supplied with energy in the passive operation mode, data can be exchanged between the M2M device 101 and the reader unit 111 independent of the power supply 112. Moreover, in the passive communication mode, the communication application 116 may be able to store data received from the reader unit 111 in a memory unit 115 for future use in the M2M device 101, and/or it is able to read data stored in the memory unit 115 and to transmit such data to the reader unit 111.

The memory unit 115 is a non-volatile data storage that is configured as a so called shared memory. It is coupled to or part of the component of the M2M device 101 providing the communication application 116 and it can be accessed by the communication application 116 and by the control module 104. However, the control module 104 may only be able to access the memory unit 115 when it is energized using the power supply 112 of the M2M device 101. The reason for this is that the power provided by the reader unit 111 using the RF field is not sufficient to energize the control module 104 of the M2M device 101 as well, in particular because the control module 104 may be a relatively complex microcontroller having relative high power consumption. Therefore, the memory unit 115 may be used as a kind of buffer in a communication between the control module 104 and the reader unit 111. When the control module 104 is supplied with power by the power supply 112, it may retrieve data from the memory unit 115, which previously have been stored there by the communication module 110 in the passive communication mode. Similarly, the control module 104 may write data to the memory unit 115, which data the communication application 116 may read from the memory unit 115 and transmit to the reader unit 111 in passive communication mode. This allows a data exchange between the reader unit 111 and the M2M device 101, when the M2M device 101 is not supplied with power.

In one embodiment, the communication module 110 and the reader unit 111 use the NFC technology for exchanging data (NFC: Near Field Communication). The NFC technology is specified in ISO 18092 and 21481, ECMA 340.352 and 356, and ETSI TS 502 109 and allows contactless communication over a short distance between several centimetres and several ten centimetres. NFC-enabled devices comprise a magnetic loop antenna operating at a frequency of 13.56 MHz and an NFC controller controlling the antenna on the physical level. The NFC controller interacts with one or more NFC applications controlling the operation of the NFC-enabled device on the application level.

Thus, when the communication module 110 of the M2M device 101 is an NFC module, the communication application 116 is configured as an NFC application. Some identification modules 109, particular SIM or USIM cards, also provide the option to install NFC applications and to interact with NFC controllers. In particular, the Single Wire Protocol (SWP) has been developed for this purpose and may be used to connect the identification module 109 and the communication module 110, when the communication application 116 is hosted in the identification module 109.

The NFC technology provides different communication modes, which correspond to different tag types defined in the NFC specifications and which differ in the communication protocols used and in the data transmission rates, for example. Type 1 and type 2 tags are based on the specification ISO 14443 type A, type 3 tags use the specification ISO 18092 and type 4 tags are compatible to the specifications ISO 14443 type A and type B. Furthermore, NFC-enabled devices can communication in an active and in a passive communication mode. In the active communication mode, each of the communicating devices generates a high frequency field at the carrier frequency in order to send data to the communication partner. In the passive communication mode, only one communication partner, which is called initiator, generates a high frequency field at the carrier frequency that is used by the initiator to transmit data to the other communication partner which is called target. The target uses load modulation for transmitting data to the initiator. This means that the current through the antenna of the target is modulated using a controllable resistor. Thus, when the M2M device 101 or the communication module 110 of the M2M device 101 may be operated as the target and the reader unit 111 may be operated as the initiator in the passive communication mode, in which the communication module 110 is energized using the RF field generated by the reader unit 111.

As mentioned before, short range communication between the reader unit 111 and the M2M device 101 may be used to transmit configuration data from the reader unit 111 to the M2M device 101. Configuration data may be any data that determines the operation of the M2M device 101. In particular, configuration data may determine one or more of the aspects of the configuration of the M2M device 101, which have been described before. Thus, the configuration data may include management and/or identification data or program routines for controlling the operation of the M2M device 101 including program routines for controlling the sensor 102 and/or the actuator 103 and program routines affecting the interaction between the M2M device 101 and the remote location 106.

For transmitting configuration data to the M2M device 101, the reader unit 111 likewise comprises a communication module 117. The communication module 117 is configured similarly to the communication module 110 of the M2M device 101. In particular, it also comprises an antenna 118 and an antenna controller 119 controlling the antenna 118 on the physical level. The antenna 118 and the antenna controller 119 may be configured according to the NFC specification. Furthermore, the reader unit 111 comprises a configuration application 121 communicating with the communication module 117. The configuration may be a software program run on a microcontroller of the reader unit 111. Preferably, the configuration application 117 is configured as an NFC application.

In contrast to the M2M device 101, the reader unit 111 comprises a user interface 120, which allows an operator to interact with the reader unit 111 and which may include a display unit and an input unit, such as, for example, a keyboard. In particular, the user interface 120 allows an operator of the reader unit 111 to control the configuration application 121.

The configuration application 121 has access to the configuration data to be transmitted to the M2M device 101. In one embodiment, the configuration data is generated by the operator of the reader unit 111 using the configuration application 121. In addition or as an alternative, the configuration data can be transmitted to the reader unit 111 from another device using a suitable communication interface of the reader unit 111.

In order to transmit the configuration data to the M2M device 101, an operator starts the corresponding functionality of the configuration application 121 and brings the M2M device 101 and the reader unit 111 in close proximity to each other. If the reader unit 111 is portable, this may be done by simply “touching” the M2M device 101 with the reader unit 111. The communication module 117 of the reader unit 111 is operated in an active mode in this situation and sends a signal that can be received within the communication distance by generating a corresponding RF field. When the RF field is strong enough at the site of the antenna 113 of the communication module 110 of the M2M device 101, the communication module 110 is activated. In the course of the communication, the reader unit 111 notifies the M2M device 101 that new configuration data are to be transmitted. Then, the configuration data are transmitted from the communication module 117 of the reader unit 111 to the communication module 110 of the M2M device 101.

When receiving the data, the communication application 116 of the M2M device 101 recognizes that the data are configuration data. Upon receipt of the configuration data, the communication application 116 controls the storage of the received data in the memory unit 115. As described before, the energy that is necessary for this process is taken from the RF field generated by the reader unit 111. After the configuration data have been stored in the memory unit 115, the communication module 110 of the M2M device 101 is deactivated again. Then, the distance between the M2M device 101 and the reader unit 111 may be increased again and/or the communication module of the reader unit 111 may be turned off again.

After the configuration data have been stored in the memory unit 115, the M2M device 101 can be installed at its site of operation, if the configuration has not been done there. Then, the M2M device 101 can be activated. This may be done by connecting the power supply 112 of the M2M device 101 to an external power supply, by manually actuating a corresponding switch of the M2M device 101 and/or by transmitting an activation signal, which is received in the communication module 110 of the M2M device 101. In the latter case, the activation signal may likewise be received by the communication module 110 in the passive communication mode.

Upon activation of the M2M device 101, the control module 104 checks whether new configuration data are stored in the memory unit 115. When the control module 104 determines that new configuration data are stored in the memory unit 115, it reads the configuration data from the memory unit 115 and installs the new configuration so that it can be used in the operation of the M2M device 101. Then, the M2M device 101 operates using the new configuration data. When the M2M device 101 already had been configured before, i.e. when configuration data were already stored and used in the M2M device 101 before the new configuration data are transmitted, the new configuration data may replace the existing configuration data. This allows for a re-configuration of the M2M device 101. Thus, the M2M device 101 can be reused in different circumstances.

As it is apparent from the description above that, from the perspective of the operator of the reader unit 111, the configuration of the M2M device 101 is simply done by touching the M2M device 101 with the reader unit 111. The M2M device 101 does not have to be powered on in this process. Thus, the configuration of the M2M device 101 can be easily integrated in the setting up of the M2M device 101 at its site of operation, for example, in a preparation of a container or another object 105 for shipping.

Furthermore, data which are collected during the operation of the M2M device 101 can be read out using the reader unit 111. As described before, the data may be measuring data of the sensor 102. Likewise, it may be management data, which have been stored in the M2M device 101 before. For allowing the data to be read using the reader unit 111, the data are stored in the memory unit 115. Management data may be stored permanently in the memory unit 115. Likewise, the control module 104 may store in the memory unit 115 selected data, which are provided for being read by the reader unit 111. In one embodiment, data which are collected in the operation of the M2M device 101 are stored in the memory unit 115 by default. If the data are also transmitted to the remote location 106 via the mobile communication network 107, storage of the data in the memory unit 115 corresponds to a backup preventing data loss. As an alternative, collected data may only be stored in the memory unit 115 in predetermined situations, while in other situations they are exclusively transmitted to the remote location 106.

Situations, in which the collected data are stored in the memory unit 115 may be situations in which the radio module 108 only has a weak connection to the mobile communication network 107 or is out of network coverage. In such situations, it may not be possible to send the data to the remote location 106 and the data may be saved by storing them in the memory unit 115. In a further embodiment, the control module 104 is configured to recognize the state-of-charge of a battery supplying the M2M device 101 with energy. When the state-of-charge falls below a predetermined threshold, the control module 104 may deactivate the radio module 108 in order to conserve power. When the radio module 108 is turned off, the data collected by the control module 104 are stored in the memory unit 115 instead of being transmitted to the remote location 106 via the mobile communication network 107. This allows a longer operating time of the M2M and prevents loss of data.

For reading data from the M2M device 101 the reader unit 111 comprises a reading application 122, which is configured to control the communication module 117 of the reader unit 111 to receive the data from the M2M device 101. Before reading the data from the M2M device 101, the operator of the reading unit 111 activates the reading application 122. Then, the operator brings the reader unit 111 and the M2M device 101 in close proximity to each other. This may again be done by “touching” the M2M device 101 with the reader unit 111. The communication module 117 of reader unit 111 is operated in an active mode in this situation and sends a signal that can be received within the communication distance by generating a corresponding RF field. When the RF field is strong enough at the site of the antenna 113 of the communication module 110 of the M2M device 101, the communication module 110 is activated.

After the communication module 110 has been activated, the reader unit 111 requests the transmission of data stored in the memory unit 115. The request is processed in the communication application 116 of the M2M device 101, which controls the communication module 110 to transmit the relevant data stored in the memory unit 115 to the reader unit 111. When the data have been received in the reader unit 111, the operator may be notified accordingly and may separate the reader unit 111 and the M2M device 101 again. The communication module 110 of the M2M device 101 is deactivated again after the transmission of the data.

Since the communication module 110 of the M2M device 101 is operated in the passive mode, when the data are transmitted to the reader unit 111, the data can be retrieved, when the M2M device 101 is disconnected from its power supply or an internal power source of the M2M device 101 is exhausted.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single processor or another unit may fulfil the functions of several items recited in the claims. The mere fact that certain measures are recited in mutually different dependent claims does not indicate that a combination of these measures cannot be used to advantage.

Any reference signs in the claims should not be construed as limiting the scope.

What is claimed is:

1. A device attachable to an object, the device comprising:
a control module for receiving measuring data from at least one sensor and/or for controlling at least one actuator; and
a communication module for communicating with an external reader unit via a radio connection using a radio field, wherein during the communication with the reader unit the communication module can be supplied with power using the radio field and the communication module is configured to store data received from the reader unit in a memory of the device and/or to read data to be transmitted to the reader unit from the memory, while the communication module is supplied with power using the radio field.

2. The device recited in claim 1, further comprising a radio module for communicating with a remote location via a communication network, particularly via a mobile communication network.

3. The device recited in claim 1, wherein the radio connection is a wireless short range connection.

4. The device recited in claim 1, wherein the radio connection is an NFC connection and the control module is an NFC-enabled module operating in a passive communication mode, when communicating with the reader unit.

5. The device recited in claim 1, comprising a power supply, wherein the stored data received from the reader unit can be forwarded to the control module, when the control module is supplied with power by the power supply.

6. The device recited in claim 5, wherein the control module is supplied with power by the power supply upon an activation of the device.

7. The device recited in claim 5, wherein data transmitted to the device are configuration data including program routines for controlling the operation of the device.

8. The device recited in claim 1, wherein the control module is configured to control storage of the data to be transmitted to the reader unit in the memory while it is supplied with power by the power supply of the device, the data being collected in the operation of the device.

9. The device recited in claim 8, wherein the collected data are measuring data of the sensor.

10. The device recited in claim 1, wherein the control module is configured to transmit data collected in the operation of the device to the remote location using the radio module.

11. The device recited in claim 1, wherein the control module is configured to store data collected in the operation in the device, when a predefined condition is fulfilled.

12. The device according to claim 11, wherein the condition is fulfilled when a connection to the remote location via the communication is not available and/or when energy reserves of the power supply means are below a predetermined threshold.

13. A system, comprising:
a device attachable to an object, the device comprising:
a control module for receiving measuring data from at least one sensor and/or for controlling at least one actuator; and
a communication module for communicating with an external reader unit via a radio connection using a radio field, wherein during the communication with the reader unit the communication module can be supplied with power using the radio field and the communication module is configured to store data received from the reader unit in a memory of the device and/or to read data to be transmitted to the reader unit from the memory, while the communication module is supplied with power using the radio field; and
a reader unit configured to generate a radio field for establishing a radio connection to the device and to receive data from the device or to transmit data to the device via the radio connection.

14. A method for communicating with a device that is attachable to an object, the method comprising:
establishing a radio connection between a communication module of the device and a reader unit using a radio field generated by the reader unit;
supplying the communication module with power using the radio field during the communication;
storing data received from the reader unit in a memory of the device, while the communication module is supplied with power by the radio field; and
forwarding the stored data from the memory to the control module of the device, when the control module is supplied with power by a power supply means of the device.

15. A method for communicating with a device that is attachable to an object, the method comprising:
collecting data with a control module during the operation of the device;
storing the data in a memory of the device, while the control module is supplied with power by a power supply of the device;
establishing a radio connection between a communication module of the device and a reader unit using a radio field generated by the reader unit;
supplying the communication module with power using the radio field during the communication; and
reading the data from the memory and transmitting the data to the reader unit, while the communication module is supplied with power by the radio field.
